(19) United States
(12) Patent Application Publication
(10) Pub. No.: US 2021/0078557 A1
(43) Pub. Date: Mar. 18, 2021

(54) ELECTRIC BRAKE DEVICE AND ELECTRIC BRAKE CONTROL DEVICE

(71) Applicant: HITACHI AUTOMOTIVE SYSTEMS, LTD., Hitachinaka-shi, Ibaraki (JP)

(72) Inventors: Tatsuro KOBUNE, Atsugi-shi, Kanagawa (JP); Daisuke KOJIMA, Atsugi-shi, Kanagawa (JP); Kimio NISHINO, Atsugi-shi, Kanagawa (JP); Sota SUZUKI, Atsugi-shi, Kanagawa (JP)

(21) Appl. No.: 16/970,811

(22) PCT Filed: Feb. 13, 2019
(86) PCT No.: PCT/JP2019/005001

§ 371 Date: Aug. 18, 2020

(30) Foreign Application Priority Data
Feb. 21, 2018 (JP) 2018-028762

(51) Int. Cl. B60T 13/74

(52) U.S. Cl. CPC B60T 13/741; B60T 17/22; B60T 13/745

(57) ABSTRACT

A rear wheel-side disc brake is provided with an electric mechanism that converts a rotative force of an electric motor into thrust by using a speed reducer and a rotation-linear motion conversion mechanism and propels (displaces) a piston. The electric motor of the electric mechanism is connected to a parking brake control device and controlled by the parking brake control device. The parking brake control device drives the electric motor to discontinue the maintenance of a braking state and then determines from a running state of a vehicle (for example, whether the vehicle starts moving) whether an abnormality (for example, an idling abnormality due to which the rotative force of the electric motor fails to be transmitted) occurs in the electric mechanism.

### TECHNICAL FIELD

The invention relates to electric brake devices that impart a braking force to a vehicle, such as an automobile, and further relates to electric brake control devices.

### BACKGROUND ART

Well-known brake devices provided to vehicles, such as automobiles, include those configured to impart a braking force to a vehicle that is stopped, parked or in another state according to the driving (rotation) of an electric motor (electrical motor) (Patent Literature 1). The brake device disclosed in Patent Literature 1 detects an abnormality in an electric parking brake on the basis of a motor current value obtained while the electric motor is driven.

### CITATION LIST

### Patent Literature

PTL 1: Japanese Unexamined Patent Application Publication (Kokai) No. 2017-65374

### SUMMARY OF INVENTION

### Technical Problem

There is a situation where, while an electric motor is driven in a direction of deactivating (releasing) an electric parking brake, the electric motor is temporarily driven in a maintaining (applying) direction in order to detect an abnormality (idling abnormality, for example) of the electric parking brake on the basis of a motor current value. In such a situation, there is a possibility, for example, that a braking force that the operator does not intend to apply is imparted when the vehicle starts and therefore that the operator has uncomfortable feeling.

### Solution to Problem

An object of the invention is to provide an electric brake device and an electric brake control device which are capable of preventing or reducing uncomfortable feeling given to the operator.

An electric brake device according to one embodiment of the invention includes an electric mechanism configured to convert a rotative force of an electrical motor into thrust using a speed reducer and a rotation-linear motion conversion mechanism and press a braking member against a braked member by propelling a piston to maintain a braking state of a vehicle; and a control device configured to obtain a running state of the vehicle and control the driving of the electrical motor. The control device drives the electrical motor to discontinue the maintenance of the braking state and then determines from the vehicle's running state whether there is an abnormality in the electrical motor.

An electric brake control device according to one embodiment of the invention controls an electrical motor of an electric mechanism that presses a braking member against a braked member of a vehicle to maintain a braking state. The electric brake control device determines whether there is an abnormality in the electric mechanism from a running state of the vehicle which is obtained when a predetermined period of time elapses after the electrical motor is driven to discontinue the maintenance of the braking state.

The electric brake device and the electric brake control device according to the one embodiment of the invention are capable of preventing or reducing uncomfortable feeling given to an operator.

### BRIEF DESCRIPTION OF DRAWINGS

FIG. 1 is a conceptual diagram of a vehicle equipped with an electric brake device according to an embodiment.

FIG. 2 is a longitudinal section showing in an enlarged scale a disc brake with an electric parking brake function which is provided to a rear-wheel side in FIG. 1.

FIG. 3 is a block diagram showing a parking brake control device in FIG. 1 together with rear wheel-side disc brakes and the like.

FIG. 4 is a flowchart showing control processing by the parking brake control device according to the embodiment.

FIG. 5 is a flowchart showing control processing by a parking brake control device according to a modification example.

### DESCRIPTION OF EMBODIMENTS

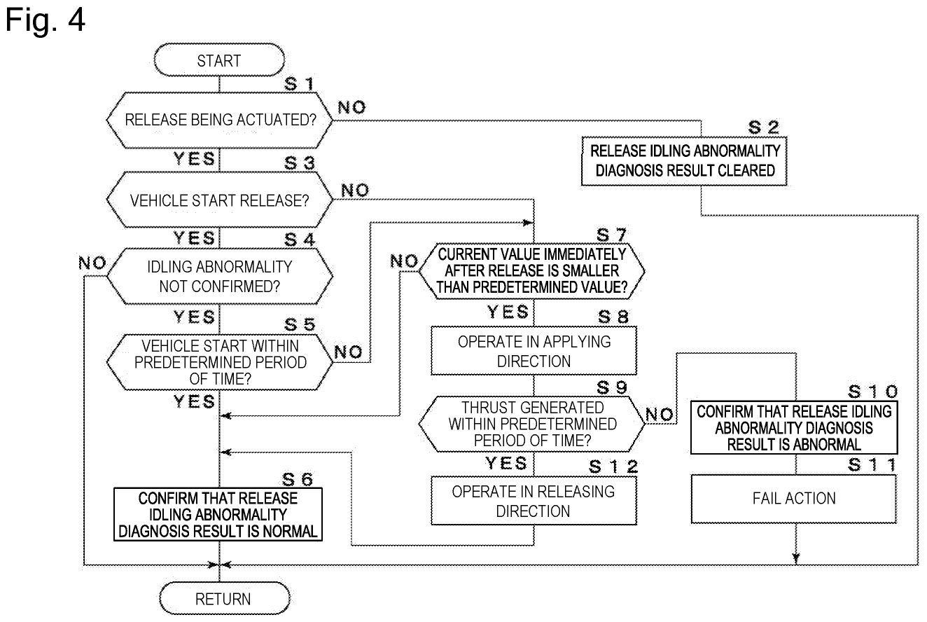

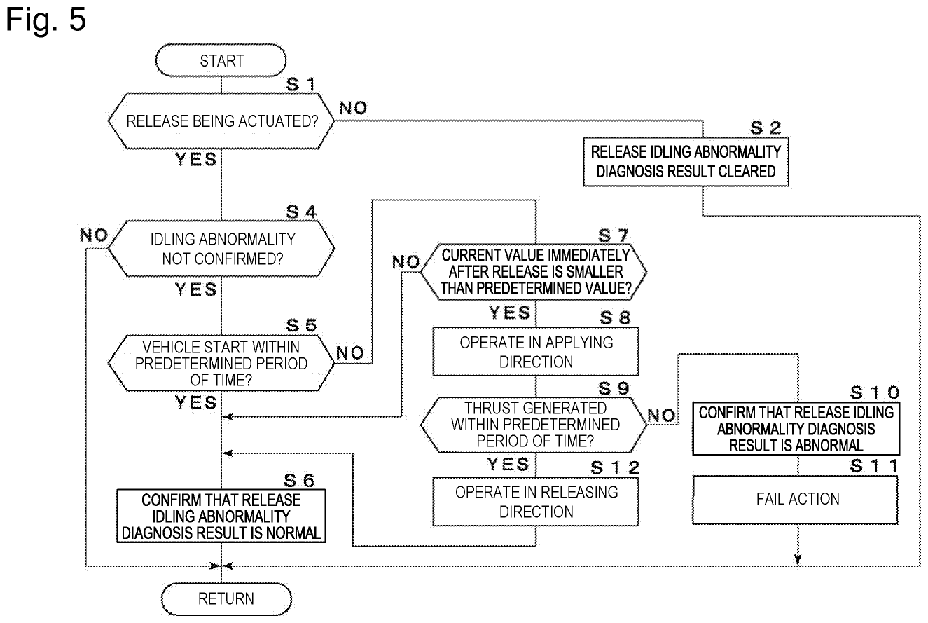

An electric brake device according to an embodiment will be discussed with reference to the attached drawings, taking as an example a case in which the electric brake device is installed in a four-wheel automobile. Steps in flowcharts of FIGS. 4 and 5 are denoted by “S” (for example, Step 1 is denoted by “S1”).

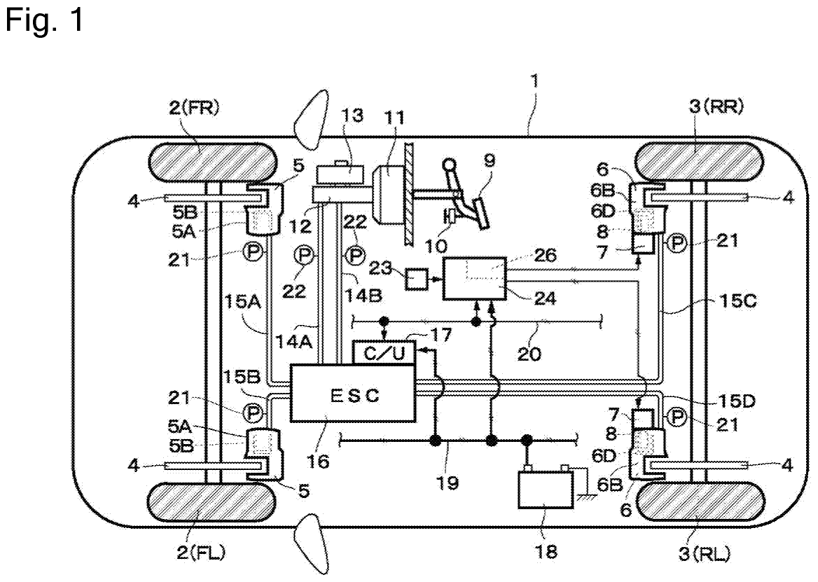

FIGS. 1 to 4 illustrate the embodiment. In FIG. 1, four wheels in total are provided on a lower side (road surface side) of a vehicle body 1 that forms a body of a vehicle. The four wheels comprise, for example, right and left front wheels 2 (FL, FR) and right and left rear wheels 3 (RL, RR). The wheels (front wheels 2 and rear wheels 3), together with the vehicle body 1, form the vehicle. The vehicle is equipped with a brake system for imparting a braking force. The brake system of the vehicle will be discussed below.

The front wheels 2 and the rear wheels 3 are provided with disc rotors 4 functioning as braked members (rotary members) that rotate with the wheels (front wheels 2 and rear wheels 3). The disc rotors 4 for the front wheels 2 are imparted with braking forces by front wheel-side disc brakes 5 that are hydraulic disc brakes. The disc rotors 4 for the rear wheels 3 are imparted with braking forces by rear wheel-side disc brakes 6 that are hydraulic disc brakes with an electric parking brake function.

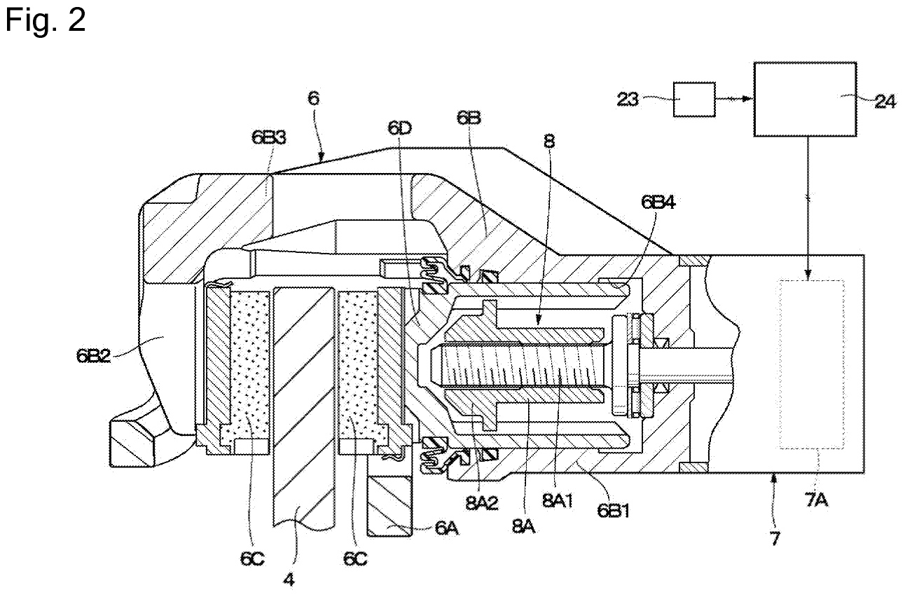

The rear wheel-side disc brakes 6 provided in a pair (a set) respectively to the right and left rear wheels 3 are hydraulic brake mechanisms (hydraulic brakes) that impart braking forces using pressing brake pads 6C against the disc rotors 4 through hydraulic pressure. As illustrated in FIG. 2, each of the rear wheel-side disc brakes 6 comprises, for example, a fixing member 6A called a carrier, a caliper 6B functioning as a wheel cylinder, a pair of the brake pads 6C functioning as braking members (friction members or lining pads), and a piston 6D functioning as a pressing member. The caliper 6B and the piston 6D form a cylinder mechanism or more specifically a cylinder mechanism that is moved by hydraulic pressure and presses the brake pads 6C against the disc rotor 4.

The fixing member 6A is fastened to a non-rotary portion of the vehicle and formed to extend across an outer peripheral side of the disc rotor 4. The caliper 6B is provided to the fixing member 6A so as to be movable in an axial direction of the disc rotor 4. The caliper 6B comprises a cylinder body portion 6B1, a claw portion 6B2, and a bridge portion 6B3 connecting the cylinder body portion 6B1 and the claw portion 6B2. The cylinder body portion 6B1 is provided with a cylinder (cylinder hole) 6B4. The piston 6D is fitted in the cylinder 6B4. The brake pad 6C is movably fixed to the fixing member 6A and disposed to be capable of coming into contact with the disc rotor 4. The piston 6D presses the brake pads 6C against the disc rotor 4.

The caliper 6B propels the brake pads 6C through the piston 6D by supplying (adding) hydraulic pressure (hydraulic brake pressure) into the cylinder 6B4 in response to operation of a brake pedal 9 or the like. In this process, the brake pads 6C are pressed against respective surfaces of the disc rotors 4 by the claw portion 6B2 of the caliper 6B and the piston 6D. Accordingly, a braking force is imparted to the corresponding rear wheel 3 that rotates with the disc rotor 4.

Each of the rear wheel-side disc brake 6 further includes an electric actuator 7 and a rotation-linear motion conversion mechanism 8. The electric actuator 7 comprises an electric motor 7A functioning as an electrical motor, a speed reducer, not shown, which decelerates the rotation of the electric motor 7A, and the like. The electric motor 7A functions as a propelling source (driving source) for propelling the piston 6D. The rotation-linear motion conversion mechanism 8 forms a maintaining mechanism (pressing member holding mechanism) that maintains the pressure of the brake pads 6C.

The rotation-linear motion conversion mechanism 8 comprises a rotation-linear motion member 8A that converts the rotation of the electric motor 7A into an axial displacement (linear displacement) of the piston 6D and propels the piston 6D. The rotation-linear motion member 8A comprises, for example, a threaded member 8A1 comprising a rod-like body in which external threads are formed, and a linear motion member 8A2 functioning as a propelling member having an internally threaded bore on an inner peripheral side thereof.

The rotation-linear motion conversion mechanism 8 converts the rotation of the electric motor 7A into the axial displacement of the piston 6D and holds the piston 6D propelled by the electric motor 7A. In other words, the rotation-linear motion conversion mechanism 8 imparts thrust to the piston 6D by the electric motor 7A, propels the brake pads 6C through the piston 6D to press the disc rotor 4, and maintains the thrust of the piston 6D.

The rotation-linear motion conversion mechanism 8, together with the electric motor 7A and the speed reducer, forms an electric mechanism of an electric parking brake. The electric mechanism converts a rotative force of the electric motor 7A into thrust using the speed reducer and the rotation-linear motion conversion mechanism 8, to thereby propel (displace) the piston 6D. The electric mechanism thus presses the brake pads 6C against the disc rotor 4 to maintain a braking state of the vehicle. The electric mechanism (namely the electric motor 7A, the speed reducer, and the rotation-linear motion conversion mechanism 8) thus configured forms the electric brake device together with a parking brake control device 24 described later.

The rear wheel-side disc brake 6 propels the piston 6D through the hydraulic pressure generated by the operation of the brake pedal 9 or the like and presses the disc rotor 4 with the brake pads 6C, to thereby impart the braking force to the wheels (rear wheels 3) and thus to the vehicle. As mentioned later, the rear wheel-side disc brake 6 furthermore propels the piston 6D through the rotation-linear motion conversion mechanism 8 by using the electric motor 7A and imparts the braking force (parking brake or auxiliary brake as needed) to the vehicle in response to an actuation request based on a signal transmitted from a parking brake switch 23 or the like.

In short, the rear wheel-side disc brake 6 drives the electric motor 7A and propels the piston 6D through the rotation-linear motion conversion member 8A, to thereby press the brake pads 6C against the disc rotor 4 and keeps the brake pads 6C pressed against the disc rotor 4. The rear wheel-side disc brake 6 is capable of maintaining the braking of the vehicle by propelling the piston 6D through the electric motor 7A according to a parking brake request signal (application request signal) that is an application request for imparting a parking brake (parking brake). In addition, the rear wheel-side disc brake 6 is capable of braking the vehicle through hydraulic pressure supplied from a hydraulic pressure source (an after-mentioned master cylinder 12 or a hydraulic pressure supply device 16 as needed) according to the operation of the brake pedal 9.

The rear wheel-side disc brake 6, as described, includes the rotation-linear motion conversion mechanism 8 that presses the brake pads 6C against the disc rotor 4 by the electric motor 7A and maintains the pressure of the brake pads 6C. The rear wheel-side disc brake 6 is capable of pressing the brake pads 6C against the disc rotor 4 through the hydraulic pressure that is added separately from the pressure by the electric motor 7A.

The front wheel-side disc brakes 5 provided in a pair (a set) respectively to the right and left front wheels 2 are configured in substantially the same manner as the rear wheel-side disc brakes 6 except for the mechanism related to operation of the parking brake. As illustrated in FIG. 1, each of the front wheel-side disc brakes 5 includes a fixing member, not shown, a caliper 5A, brake pads, not shown, a piston 5B and the like but does not include the electric actuator 7 (electric motor 7A) for activating and deactivating the parking brake, the rotation-linear motion conversion mechanism 8, and the like. The front wheel-side disc brakes 5 are similar to the rear wheel-side disc brakes 6 in propelling the piston 5B through hydraulic pressure generated by the operation of the brake pedal 9 or the like and imparting a braking force to the wheels (front wheels 2) and thus to the vehicle. The front wheel-side disc brakes 5 are hydraulic brake mechanisms (hydraulic brakes) that impart the braking force by pressing the brake pads against the disc rotors 4 through hydraulic pressure.

Each of the front wheel-side disc brakes 5 may be a disc brake with an electric parking brake function like the rear wheel-side disc brakes 6. The embodiment uses the hydraulic disc brakes 6 with the electric motors 7A as electric brake mechanisms (electric parking brakes). The electric brake mechanisms, however, do not have to be the hydraulic disc brakes 6. Each of the electric brake mechanisms instead may be, for example, an electric disc brake with an electric caliper, an electric drum brake that pushes shoes onto a drum by an electric motor to impart a braking force, a disc brake with an electric drum-type parking brake, a cable puller-type electric parking brake that actuates a parking brake to apply a brake by pulling a cable using an electric motor or another like brake. In other words, the electric brake mechanism may be of any kind as long as the electric brake mechanism is configured to press (propel) friction members (pads or shoes) against a rotary member (rotor or drum) in response to the driving of the electric motor (electric actuator) and is capable of maintaining and releasing the pressure.

The brake pedal 9 is provided on a front board side of the vehicle 1. The brake pedal 9 is depressed by an operator (driver) during a braking operation of the vehicle. In response to this operation, a braking force is imparted and stopped being imparted to each of the disc brakes 5 and 6 as a regular brake (service brake). The brake pedal 9 is provided with a brake lamp switch, a pedal switch (brake switch), and a brake operation detection sensor (brake sensor) 10, such as a pedal stroke sensor.

The brake operation detection sensor 10 detects whether the brake pedal 9 is depressed or a depression degree of the brake pedal 9 and outputs a detection signal to an ESC control device 17. The detection signal of the brake operation detection sensor 10 is transmitted, for example, through a vehicle data bus 20 or a communication wire, not shown, which connects the ESC control device 17 and the parking brake control device 24 (outputted to the parking brake control device 24).

The depression of the brake pedal 9 is transmitted through a booster device 11 to the master cylinder 12 that functions as a fluid pressure source (hydraulic pressure source). The booster device 11 is configured as a negative pressure booster (pneumatic booster device) or an electric booster (electric booster device) that is provided between the brake pedal 9 and the master cylinder 12. The booster device 11 increases and transmits a depressing force to the master cylinder 12 during the depression of the brake pedal 9.

The master cylinder 12 generates hydraulic pressure out of brake fluid that is supplied (replenished) from a master reservoir 13. The master reservoir 13 is a hydraulic fluid tank in which the brake fluid is contained. The mechanism that generates the hydraulic pressure by using the brake pedal 9 does not necessarily have to be configured in the foregoing manner. The mechanism may be one that generates hydraulic pressure in response to the operation of the brake pedal 9, which is, for example, a brake-by-wire mechanism or the like.

The hydraulic pressure generated in the master cylinder 12 is delivered to the hydraulic pressure supply device 16 (hereinafter, referred to as ESC 16), for example, through a pair of cylinder-side hydraulic pressure ducts 14A and 14B. The ESC 16 is disposed between the disc brakes 5 and 6 on one side and the master cylinder 12 on the other. The ESC 16 distributes and supplies the hydraulic pressure, which is outputted from the master cylinder 12 through the cylinder-side hydraulic pressure ducts 14A and 14B, to the disc brakes 5 and 6 through brake-side duct portions 15A, 15B, 15C and 15D. The ESC 16 is intended to supply the hydraulic pressure (hydraulic brake pressure) corresponding to the operation of the brake pedal 9 to the disc brakes 5 and 6 (calipers 5A and 6B) provided to each of the wheels (each of the front wheels 2 and each of the rear wheels 3). This makes it possible to impart braking forces to the wheels (front wheels 2 and rear wheels 3) separately from one another.

The ESC 16 is a hydraulic pressure control device that controls the hydraulic pressure of the hydraulic brakes (front wheel-side disc brakes 5 and rear wheel-side disc brakes 6). The ESC 16 therefore comprises a plurality of control valves, a hydraulic pump for pressurizing the hydraulic brake pressure, an electric motor for driving the hydraulic pump, and a hydraulic pressure control reservoir for temporary storage of excess brake fluid, none shown. The control valves and the electric motor of the ESC 16 are connected to the ESC control device 17. The ESC 16 comprises the ESC control device 17.

The opening/closing of the control valves and the driving of the electric motor in the ESC 16 are controlled by the ESC control device 17. In other words, the ESC control device 17 is a control unit for an ESC (ECU for an ESC) which controls the ESC 16. The ESC control device 17 comprises a microcomputer and electrically implements drive control on (solenoids of the control valves and the electric motor of) the ESC 16. The ESC control device 17, for example, controls the hydraulic pressure supply of the ESC 16 and is provided in a built-in manner with an arithmetic circuit that detects a failure in the ESC 16, a drive circuit that drives the electric motor and the control valves, neither shown, and the like.

The ESC control device 17 implements the drive control on (the solenoids of) the control valves of the ESC 16 and the electric motor for the hydraulic pump individually. The ESC control device 17 thus implements control for reducing, maintaining, increasing or pressurizing the hydraulic brake pressure (wheel cylinder hydraulic pressure) that is supplied to the disc brakes 5 and 6 through the brake-side duct portions 15A, 15B, 15C and 15D with respect to each of the disc brakes 5 and 6.

The ESC control device 17 is capable of implementing, for example, the following controls (1) to (8) or the like by implementing actuation control on the ESC 16. (1) Braking force distribution control for properly distributing braking forces to the wheels 2 and 3 at the time of braking the vehicle according to vertical load or the like. (2) Antilock brake control (hydraulic ABS control) for automatically adjusting the braking forces of the wheels 2 and 3 at the time of braking and thus preventing the wheels 2 and 3 from being locked (slipping). (3) Vehicle stability control for detecting the skidding of the wheels 2 and 3 during the running of the vehicle, repressing understeer and oversteer while properly and automatically controlling the braking forces imparted to the wheels 2 and 3, regardless of the depression degree of the brake pedal 9, and thus stabilizing the behavior of the vehicle. (4) Hill start aid control for maintaining a braking state on a hill (especially on an upslope) and thus aiding the start of the vehicle. (5) Traction control for preventing the wheels 2 and 3 from running idle at the start of the vehicle or the like. (6) Vehicle follow-up control for keeping a constant distance from a preceding vehicle. (7) Lane departure avoidance control for keeping a driving lane. (8) Obstacle avoidance control (automatic brake control, advanced emergency braking control) for avoiding a collision against an obstacle located in a vehicle's moving direction.

During a normal behavior by the operator's brake operation, the ESC 16 supplies the hydraulic pressure generated in the master cylinder 12 directly to (the calipers 5A and 6B of) the disc brakes 5 and 6. However, for example, to implement the antilock brake control or the like, the ESC 16 closes a pressure-increasing control valve to maintain the hydraulic pressure of the disc brakes 5 and 6. To reduce the hydraulic pressure of the disc brakes 5 and 6, the ESC 16 opens a pressure-reducing control valve to release the hydraulic pressure of the disc brakes 5 and 6 into the hydraulic pressure control reservoir.

To increase or pressurize the hydraulic pressure supplied to the disc brakes 5 and 6 for the purpose of implementing the stabilization control (skidding prevention control) or the like during the running of the vehicle, the hydraulic pump is actuated by the electric motor with a supply control valve closed, and the brake fluid discharged from the hydraulic pump is supplied to the disc brakes 5 and 6. The brake fluid contained in the master reservoir 13 is supplied from the master cylinder 12 side to a suction side of the hydraulic pump.

The ESC control device 17 is supplied with electric power from a battery 18 (or a generator driven by an engine) functioning as a vehicle power source through a power source line 19. As illustrated in FIG. 1, the ESC control device 17 is connected to the vehicle data bus 20. Instead of the ESC 16, a publicly-known ABS unit may be utilized. It is also possible to connect the master cylinder 12 directly to the brake-side duct portions 15A, 15B, 15C and 15D without providing the ESC 16 (that is, the ESC 16 may be omitted).

The vehicle data bus 20 forms a CAN (Controller Area Network) functioning as a serial communication portion installed in the vehicle body 1. A number of electronic devices installed in the vehicle (various kinds of ECUs including, for example, the ESC control device 17, the parking brake control device 24 and the like) have multi-channel communication in the vehicle with one another through the vehicle data bus 20. Vehicle information that is sent to the vehicle data bus 20 includes information (vehicle information) that is delivered through detection signals (output signals) issued, for example, from a brake operation detection sensor 10, an ignition switch, a seatbelt sensor, a door lock sensor, a door open sensor, a seating sensor, a vehicle speed sensor, a steering angle sensor, an accelerator sensor (accelerator operation sensor), a throttle sensor, an engine revolution sensor, a digital camera (which may be a stereo camera), a millimeter-wave radar, a gradient sensor (inclination sensor), a shift sensor (transmission data), an acceleration sensor (G sensor), a wheel speed sensor, a pitch sensor for detecting the vehicle's motion in a pitch direction or the like.

The vehicle information that is sent to the vehicle data bus 20 further includes detection signals (information) from a W/C pressure sensor 21 that detects wheel cylinder pressure and a M/C pressure sensor 22 that detects master cylinder pressure. The W/C pressure sensor 21 and the M/C pressure sensor 22 are connected, for example, to the ESC control device 17 as well as the brake operation detection sensor 10. The detection signals of the W/C pressure sensor 21 and the M/C pressure sensor 22 are sent from the ESC control device 17 to the vehicle data bus 20 as information about W/C hydraulic pressure and M/C hydraulic pressure. A number of the electronic devices (various kinds of ECUs) installed in the vehicle are capable of obtaining a variety of the vehicle information including the W/C hydraulic pressure and the M/C hydraulic pressure through the vehicle data bus 20.

The parking brake switch 23 and the parking brake control device 24 will be now discussed.

The parking brake switch (PKB-SW) 23 that functions as a switch of the electric parking brake (electrical parking brake) is provided near a driver's seat, not shown, in the vehicle body 1. The parking brake switch 23 is an operation command portion that is operated by the operator. The parking brake switch 23 transmits to the parking brake control device 24 a signal (actuation request signal) corresponding to a parking brake actuation request (an application request as a maintain request or a release request as a deactivation request) according to an operation command issued by the operator. The parking brake switch 23 outputs to the parking brake control device 24 the actuation request signal (an application request signal as a maintenance request signal or a release request signal as a deactivation request signal) for bringing the piston 6D and therefore the brake pads 6C into application actuation (maintenance actuation) or release actuation (deactivation actuation) on the basis of the driving (rotation) of the electric motor 7A. The parking brake control device 24 is a control unit for a parking brake (ECU for a parking brake).

When the parking brake switch 23 is operated to a braking side (application side) by the operator, that is, when the application request (braking maintain request) for imparting the braking force to the vehicle is issued, the application request signal (parking brake request signal, application command) is outputted from the parking brake switch 23. In such a case, the electric motor 7A of the rear wheel-side disc brake 6 is supplied through the parking brake control device 24 with electric power for rotating the electric motor 7A to the braking side. The rotation-linear motion conversion mechanism 8 propels (presses) the piston 6D toward the disc rotor 4 in response to the rotation of the electric motor 7A and holds the propelled piston 6D. Accordingly, the rear wheel-side disc brake 6 is imparted with the braking force as the parking brake (or auxiliary brake), that is, comes into an applied state (braking maintained state).

When the parking braking switch 23 is operated to a braking cancellation side (release side) by the operator, that is, when the release request (braking cancellation request) for releasing the braking force of the vehicle is issued, a release request signal (parking brake deactivation request signal, release command) is outputted from the parking brake switch 23. In such a case, the electric motor 7A of the rear wheel-side disc brake 6 is supplied through the parking brake control device 24 with electric power for rotating the electric motor 7A in an opposite direction to the braking side. The rotation-linear motion conversion mechanism 8 discontinues the maintenance of the piston 6D through the rotation of the electric motor 7A (releases the pressure applied by the piston 6D). Consequently, the rear wheel-side disc brake 6 is stopped being imparted with the braking force as the parking brake (or auxiliary brake), that is, comes into a release state (braking cancellation state).

The parking brake may be automatically applied (automatic application) in response to an automatic application request issued by a parking brake application determination logic in the parking brake control device 24, for example, when the vehicle is stopped for a predetermined period of time (it is determined that the vehicle is stopped, for example, if the speed detected by the vehicle speed sensor remains lower than 5 km/h for a predetermined period of time due to deceleration during the vehicle's running), when the engine is stopped, when a shift lever is shifted to a park position, when a door is opened, when a seatbelt is unfastened or in another like situation. The parking brake also may be automatically deactivated (automatic release) in response to an automatic release request issued by a parking brake release determination logic in the parking brake control device 24, for example, when the vehicle runs (it is determined that the vehicle runs, for example, if the speed detected by the vehicle speed sensor remains equal to or higher than 6 km/h for a predetermined period of time as the vehicle starts from a stopped position and is accelerated), when an accelerator is operated, when a clutch pedal is operated, when the shift lever is shifted to a position other than the park position and a neutral position or in another like situation. The automatic application and the automatic release may be performed as auxiliary functions used in the event of a switch failure, which automatically impart or release the braking force when the parking brake switch 23 fails.

When the parking brake switch 23 is operated during the running of the vehicle, or more specifically, when a dynamic parking brake (dynamic application) request to use the parking brake as the auxiliary brake as an emergency measure or to take another like action is issued during the running of the vehicle, it is possible, for example, to impart and release the braking force by using the ESC 16 according to the operation of the parking brake switch 23. In such a case, for example, the parking brake control device 24 outputs a brake command (for example, a hydraulic pressure request signal or a target hydraulic pressure signal) according to the operation of the parking brake switch 23 to the ESC control device 17 through the vehicle data bus 20 or the communication wire. The ESC 16 thus imparts the braking force generated by the hydraulic pressure according to the brake command issued by the parking brake control device 24 while the parking brake switch 23 is operated to the braking side (while the operation of the parking brake switch 23 toward the braking side continues). When the foregoing operation is terminated, the ESC 16 discontinues the impartation of the braking force using the hydraulic pressure.

When the parking brake switch 23 is operated while the vehicle is running, it is also possible to impart and release the braking force, for example, by driving the electric motor 7A of the rear wheel-side disc brake 6, instead of using the ESC 16 to impart and release the braking force. In such a case, for example, the parking brake control device 24 imparts the braking force while the parking brake switch 23 is operated to the braking side (while the operation of the parking brake switch 23 toward the braking side continues). When the foregoing operation is terminated, the parking brake control device 24 discontinues the impartation of the braking force. At this time, the parking brake control device 24 may automatically impart and release the braking force (ABS control) depending on the state of the wheels (rear wheels 3), that is, whether the wheels are locked (slip).

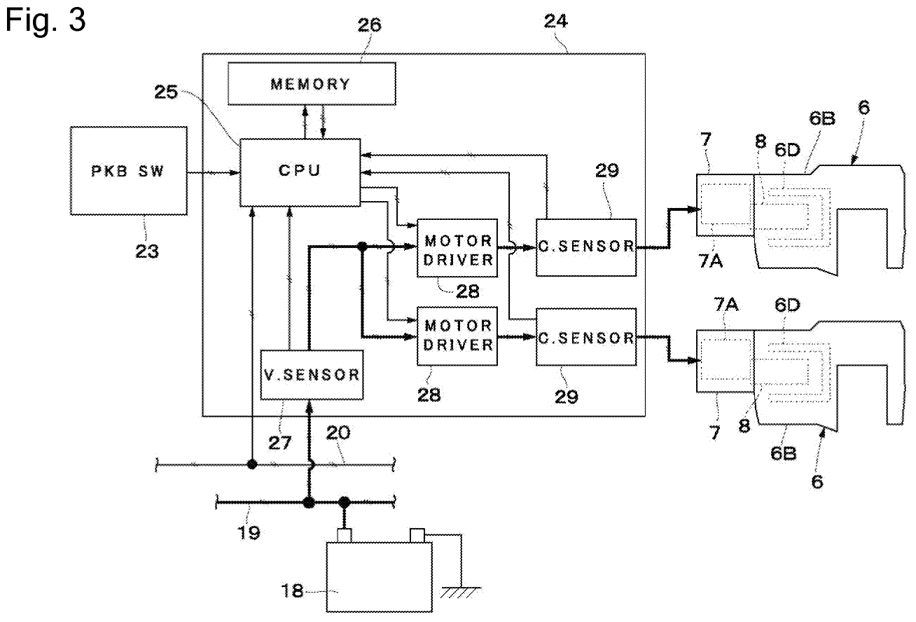

The parking brake control device 24 as a control device (electric brake control device) forms the electric brake device together with (the electric motors 7A and the rotation-linear motion conversion mechanisms 8 of) the rear wheel-side disc brakes 6. The parking brake control device 24 controls the electric motors 7A of the electric mechanism which press the brake pads 6C against the disc rotors 4 of the vehicle 4 and thus maintain the braking state of the vehicle. In such a case, as described later, the parking brake control device 24 obtains the running state of the vehicle and controls the driving of the electric motors 7A. As illustrated in FIG. 3, therefore, the parking brake control device 24 includes an arithmetic circuit (CPU) 25 comprising a microcomputer and the like, and a memory 26. The parking brake control device 24 is supplied with electric power from the battery 18 (or the generator driven by the engine) through the power source line 19.

The parking brake control device 24 controls the driving of the electric motors 7A, 7A of the rear wheel-side disc brakes 6, 6 and causes the electric motors 7A, 7A to generate the braking forces (parking brake, auxiliary brake) when the vehicle is parked or stopped (or running as needed). In other words, the parking brake control device 24 actuates (applies/releases) the disc brakes 6, 6 as a parking brake (auxiliary brake as needed) by driving the right and left electric motors 7A, 7A. To that end, the parking brake control device 24 is connected to the parking brake switch 23 at an input side and connected to the electric motors 7A, 7A of the disc brakes 6, 6 at an output side. The parking brake control device 24 includes the built-in arithmetic circuit 25 for detecting the operation (operation of the parking brake switch 23) by the operator, making a determination of availability of the driving of the electric motors 7A, 7A and a determination as to whether the electric motors 7A, 7A are stopped, and carrying out other like performances, and further includes built-in motor drive circuits 28, 28 for controlling the electric motors 7A, 7A.

More specifically, on the basis of an actuation request (application request or release request) issued by the operator's operation of the parking brake switch 23, an actuation request issued by a parking brake application/release determination logic, and an actuation request by the ABS control, the parking brake control device 24 drives the right and left electric motors 7A, 7A and applies (holds) or releases (deactivates) the right and left disc brakes 6, 6. In the rear wheel-side disc brake 6, the piston 6D and the brake pads 6C are held or released by the rotation-linear motion conversion mechanism 8 in accordance with the driving of the electric motor 7A. In this manner, the parking brake control device 24 implements drive control on the electric motor 7A to propel the piston 6D (therefore the brake pads 6C) in response to the actuation request signal for the holding actuation (application) or the release actuation (release) of the piston 6D (therefore the brake pads 6C).

As illustrated in FIG. 3, connected to the arithmetic circuit 25 of the parking brake control device 24 are the parking brake switch 23, the vehicle data bus 20, a voltage sensor portion 27, the motor drive circuits 28, current sensor portions 29 and the like as well as the memory 26 as a storage portion. Various kinds of state quantities of the vehicle, namely various kinds of vehicle information, which is necessary for controlling (actuating) the parking brake can be obtained through the vehicle data bus 20. The parking brake control device 24 is capable of outputting the information and the commands to various kinds of ECUs including the ESC control device 17 through the vehicle data bus 20 or the communication wire.

The vehicle information obtained through the vehicle data bus 20 may be obtained by connecting the sensor that detects the information directly to (the arithmetic circuit 25 of) the parking brake control device 24. The arithmetic circuit 25 of the parking brake control device 24 may receive the input of the actuation requests based on the determination logics or the ABS control from another control device (for example, the ESC control device 17) connected to the vehicle data bus 20. In such a case, the determination of application/release of the parking brake by the determination logic and the ABS control may be carried out by another control device, for example, the ESC control device 17, instead of the parking brake control device 24. In other words, the control's contents of the parking brake control device 24 can be integrated into the ESC control device.

The parking brake control device 24 includes the memory 26 as a storage portion comprising, for example, a flash memory, a ROM, a RAM, an EEPROM and the like. Stored in the memory 26 are programs for the parking brake application/release determination logic and the ABS control. In addition, the memory 26 further stores a processing program for carrying out a processing flow illustrated in FIG. 4 (or FIG. 5) explained later, that is, a processing program used for control processing of abnormality determination with respect to the electric parking brake or another like program.

According to the Embodiment, the parking brake control device 24 is a separate body from the ESC control device 17. However, the parking brake control device 24 and the ESC control device 17 may be constructed in an integral manner (that is, integrally formed into a single control device for braking). The parking brake control device 24 controls the two right and left rear wheel-side disc brakes 6, 6. Instead, it is possible to provide the parking brake control device 24 to each of the right and left rear wheel-side disc brakes 6, 6. In such a case, the parking brake control devices 24 may be provided to the respective rear wheel-side disc brakes 6 in an integral manner.

As illustrated in FIG. 3, the parking brake control device 24 includes in a built-in manner the voltage sensor portion 27 that detects voltage supplied through the power source line 19, the right and left motor drive circuits 28, 28 that drive the right and left electric motors 7A, 7A, the right and left current sensor portions 29, 29 that detect motor currents of the right and left electric motors 7A, 7A, and the like. The voltage sensor portion 27, the motor drive circuits 28, and the current sensor portions 29 are connected to the arithmetic circuit 25. This allows the arithmetic circuit 25 of the parking brake control device 24 to make a determination as to contact/detachment between the disc rotor 4 and the brake pads 6C, a determination as to stop of the driving of the electric motor 7A (determination as to completion of application or determination as to completion of release) and the like when the application or release is actuated on the basis of (a change of) the current value of the electric motor 7A which is detected by the current sensor portion 29.

For example, when a current value of the electric motor 7A reaches a current threshold value of the completion of application (holding current threshold value) while the electric motor 7A is driven in the applying direction, it is determined that the application is completed, and the driving of the electric motor 7A is stopped. For example, when the current value of the electric motor 7A reaches a current threshold value of the completion of release (release current threshold value) while the electric motor 7A is driven in the releasing direction, it is determined that the release is completed, and the driving of the electric motor 7A is stopped. The parking brake control device 24 is capable of controlling the driving of the electric motor 7A in accordance with (a change of) the current value of the electric motor 7A which is detected by the current sensor portion 29.

As described in the aforementioned Patent Literature 1, the parking brake control device 24 is capable of detecting an abnormality in the electric parking brake on the basis of the current value (motor current value) of the electric motor 7A which is detected by the current sensor portion 29. In such a case, the electric motor 7A might be driven in a temporarily maintaining (applying) direction in order to detect an abnormality (idling abnormality, for example) of the electric parking brake on the basis of the motor current value, for example, when the electric motor 7A is driven in a direction of deactivating (releasing) the electric parking brake. In this case, however, there is a possibility, for example, that a braking force that the operator does not intend to apply is imparted when the vehicle starts and therefore that the operator has uncomfortable feeling.

Abnormalities that might be generated in the electric mechanism comprising the electric motor 7A, the deceleration mechanism, the rotation-linear motion conversion mechanism 8, and the like include an idling abnormality. When the idling abnormality occurs, for example, power (rotative force) of the electric motor 7A fails to be transmitted to the linear motion member 8A2 due to a damage of the speed reducer or the rotation-linear motion conversion mechanism 8. The motor current value when an idling abnormality occurs and the motor current value when the electric parking brake is normally deactivated both become current values corresponding to a no-load condition. This makes it difficult to discriminate the “idling abnormality” from the “normal deactivation” on the basis of the motor current values.

One idea for solving the foregoing difficulty is to provide a thrust sensor or a position sensor to the electric mechanism and determine on the basis of a result of detection by the thrust sensor or the position sensor whether the “idling abnormality” occurs or the “normal deactivation” is performed. On the other hand, the providing of the thrust sensor or the position sensor might increase costs. Another possible solution is, for example, to generate thrust (load) by driving the electric motors 7A temporarily in the applying direction when releasing the electric parking brake, and detect whether an idling abnormality occurs on the basis of a change of the motor current value in the foregoing process. In such a case, however, there is a possibility, for example, that a braking force that the operator does not intend to apply is imparted when the vehicle starts (deceleration is temporarily generated in the vehicle) as a result of the driving of the electric motor 7A in the applying direction and therefore that the operator has uncomfortable feeling.

The embodiment, therefore, determines from the running state of the vehicle at the time of start whether the deactivation of the electric parking brake is accomplished. More specifically, at the time of releasing the electric parking brake to start the vehicle, the availability of the vehicle start is checked on the basis of information about the vehicle's running state including the speed (wheel speed) of the wheels (rear wheels 3) on which the electric parking brake is mounted, and the like. In this way, a determination is made as to whether there is a failure (abnormality) in the electric parking brake. This prevents or reduces an uncomfortable feeling given to the operator when the vehicle starts.

In other words, the parking brake control device 24 according to the embodiment obtains the information of the vehicle's running state and controls the driving of the electric motor 7A of the electric mechanism. The electric mechanism is intended to maintain the braking state of the vehicle by pressing the brake pads 6C against the disc rotors 4 of the vehicle. The electric mechanism comprises, for example, the speed reducer, the rotation-linear motion conversion mechanism 8, the electric motor 7A, and the like. The parking brake control device 24 obtains the information of the vehicle's running state, for example, through the vehicle data bus 20. The parking brake control device 24 obtains, for example, at least one of vehicle speed, wheel speed, and acceleration as information (state quantity) corresponding to the vehicle's running state. On the basis of vehicle speed, wheel speed, and acceleration, the parking brake control device 24 is capable of detecting, for example, initial motion of the vehicle.

The parking brake control device 24 obtains information (vehicle information) through the vehicle data bus 20. The information includes, for example, an accelerator position, a throttle position, engine speed, an engine torque command value, fuel injection amount, a shift position (a selected position of the shift lever), and the like. The parking brake control device 24 further obtains, through the vehicle data bus 20, information about environment around the vehicle (for example, information of a traffic light ahead of the vehicle) and the like which is acquired by an environment visual recognition device, such as a digital camera. The parking brake control device 24 is capable of making a determination, for example, as to whether the vehicle is about to start, that is, whether a vehicle starting condition is satisfied on the basis of the accelerator position, the throttle position, the engine speed, the engine torque command value, the fuel injection amount, the shift position, the traffic light information, and information about operation of the parking brake switch 23 connected to the parking brake control device 24.

A variety of the vehicle information including information corresponding to the vehicle's running state and/or information about whether the vehicle starting condition is satisfied is not limited to the foregoing. Vehicle information other than the aforementioned information may be used, which includes, for example, position information acquired by GPS, traffic control information, and the like. The vehicle information obtained through the vehicle data bus 20 may be obtained by connecting the sensor that detects the vehicle information or the like directly to (the arithmetic circuit 25 of) the parking brake control device 24. It is not always necessary to obtain all the vehicle information mentioned above. As the information corresponding to the vehicle's running state and/or the information about whether the vehicle starting condition is satisfied, at least either one of them, whichever is necessary, may be obtained.

The parking brake control device 24 at any rate drives the electric motors 7A to discontinue the maintenance of the braking state and then determines whether there is an abnormality in the electric mechanism (for example, the idling abnormality due to which the rotative force of the electric motor 7A fails to be transmitted) from the vehicle's running state (for example, whether the vehicle starts moving). In other words, the parking brake control device 24 determines whether there is an abnormality in the electric mechanism (for example, whether the idling abnormality occurs) on the basis of the vehicle's running state (wheel speed, for example) that is obtained when a predetermined period of time (for example, a few seconds) elapses after the electric motors 7A are driven to discontinue the maintenance of the braking state. In such a case, the parking brake control device 24 determines whether there is an abnormality in the electric mechanism from the vehicle's running state after the vehicle starting condition is satisfied, and the the electric motors 7A are driven to discontinue the maintenance of the braking state.

The vehicle starting condition corresponds to a condition for beginning the driving of the electric motors 7A. To be more specific, the vehicle starting condition corresponds to a condition for beginning the driving of the electric motors 7A in the releasing direction. The vehicle starting condition (whether the vehicle starting condition is satisfied) is determined by detecting a change in at least one piece of information among the accelerator position, the throttle position, the engine torque command value, the fuel injection amount, the shift position, the parking brake switch information, and the traffic light information. For example, if the accelerator position exceeds a predetermined value (a position that enables the vehicle to start), the parking brake control device 24 determines that the vehicle starting condition is satisfied.

If the throttle position exceeds a position that enables the vehicle to start, if the engine torque command value exceeds torque that enables the vehicle to start, if the fuel injection amount exceeds injection amount that enables the vehicle to start, if the shift position is at a position corresponding to the start of the vehicle (for example, a drive position, first gear), if the parking brake switch 23 is operated in the releasing direction and/or if image information of a digital camera installed in the vehicle (or traffic control information) informs that a traffic light ahead of the vehicle is switched to “go” (green light), it can be determined that the vehicle starting condition is satisfied. Predetermined values, namely the position, the torque, and the injection amount which enable the vehicle to start, are previously obtained, for example, by calculation, an experiment, simulation or the like so as to reach values (threshold values, judgment values) that enable an accurate determination of the start of the vehicle. The predetermine values are then stored in the memory 26 of the parking brake control device 24.

After the vehicle starting condition is satisfied, and the electric motors 7A are driven in the releasing direction, the parking brake control device 24 determines whether there is an abnormality in the electric mechanism from the vehicle's running state. When detecting the vehicle's initial motion as the running state, the parking brake control device 24 determines that the electric mechanism is normal. That is, the parking brake control device 24 determines that the electric mechanism is normal (for example, no idling abnormality occurs) when detecting the vehicle's initial motion after driving the electric motors 7A in the releasing direction. The vehicle's initial motion can be detected on the basis of a change in at least one of acceleration, vehicle speed, and wheel speed.

For example, when a change in the acceleration, the vehicle speed or the wheel speed exceeds a predetermined range (that is, a possible range while the vehicle is parked) when a predetermined period of time (for example, after a few seconds or a few tens of seconds) elapses after the electric motors 7A are driven in the releasing direction, the parking brake control device 24 determines that the vehicle's initial motion is detected. The acceleration may be, for example, acceleration obtained by a longitudinal acceleration sensor (G sensor) or acceleration obtained by differentiating the vehicle speed. The predetermined range can be set, for example, so as to correspond to each of the acceleration, the wheel speed, and the vehicle speed.

In the foregoing case, the predetermine range (namely, a predetermined value for determining the vehicle's initial motion) is previously obtained, for example, by calculation, an experiment, simulation or the like so as to become a range (threshold values, judgment values) that enables an accurate determination of the vehicle's initial motion. The predetermined range is then stored in the memory 26 of the parking brake control device 24. It is not always necessary to use all of the acceleration, the vehicle speed, and the wheel speed to detect the vehicle's initial motion. The detection can be performed using at least one of them (for example, wheel speed). The predetermined period of time that elapses after the electric motors 7A are driven in the releasing direction is previously obtained, for example, by calculation, an experiment, simulation or the like so as to become a period of time that enables an accurate determination as to whether an abnormality (idling abnormality, for example) occurs in the electric mechanism on the basis of the detection of the vehicle's initial motion. The predetermined period of time is then stored in the memory 26 of the parking brake control device 24.

The parking brake control device 24 determines that there is an abnormality in the electric mechanism when a change in at least one of the acceleration, the vehicle speed, and the wheel speed is in the predetermined range. In other words, if the vehicle's initial motion is not detected from the acceleration, the vehicle speed or the wheel speed after the electric motors 7A are driven in the releasing direction (for example, when the predetermined period of time elapses after the electric motors 7A are driven), the parking brake control device 24 determines that there is an abnormality (idling abnormality, for example) in the electric mechanism. The parking brake control device 24 drives the electric motors 7A in a direction of maintaining the braking state when it is determined that the electric mechanism has an abnormality. In other words, if the vehicle's initial motion is not detected, the parking brake control device 24 drives the electric motors 7A in the applying direction.

Thrust is thus generated in the linear motion members 8A2 of the rotation-linear motion conversion mechanisms 8 (load is generated in the electric motors 7A). On the basis of a change of the motor current value at this point of time, it is detected whether an idling abnormality occurs. If the vehicle's initial motion is not detected after the electric motors 7A are driven in the releasing direction, there is a possibility that an idling abnormality occurs. Therefore, in order to confirm whether the idling abnormality actually occurs, the electric motors 7A are driven in the direction where the load is generated (applying direction), and it is determined whether the reason that the initial motion is not detected is the occurrence of an idling abnormality.

If the parking brake control device 24 drives the electric motors 7A in the applying direction and determines that the idling abnormality occurs, the parking brake control device 24 accordingly notifies. The parking brake control device 24 informs of the idling abnormality, for example, by blinking a parking brake working light. It is also possible to inform of the idling abnormality, for example, by turning on a warning light, indicating the occurrence of the idling abnormality in a monitor of a car navigation system or a meter monitor or generating warning sounds. The parking brake control device 24 thus prompts the operator to carry out action to be taken in the event of occurrence of an idling abnormality (for example, to stop the vehicle in a safe area, avoid dangers, fix the malfunction or take another like action). The control of abnormality determination during the release which is made by the parking brake control device 24, namely the control processing illustrated in FIG. 4, will be discussed later in detail.

The brake system of the four-wheel automobile according to the embodiment is configured as described above. Operation of the brake system will be now discussed.

When the operator of the vehicle depresses the brake pedal 9, a depressing force is transmitted to the master cylinder 12 through the booster device 11, and the hydraulic brake pressure is generated by the master cylinder 12. The hydraulic brake pressure generated in the master cylinder 12 is distributed to the disc brakes 5 and 6 through the cylinder-side hydraulic pressure ducts 14A and 14B, the ESC 16, and the brake-side duct portions 15A, 15B, 15C and 15D. The distributed braking forces are then imparted to the right and left front wheels 2 and the right and left rear wheels 3.

In the disc brakes 5 and 6, the pistons 5B and 6D are displaced toward the brake pads 6C in a sliding manner along with an increase of the hydraulic brake pressure in the calipers 5A and 6B, and the brake pads 6C are pressed against the disc rotors 4, 4. The braking force based on the hydraulic brake pressure is thus imparted. When the brake operation is cancelled, the hydraulic brake pressure stops being supplied into the calipers 5A and 6B, and the pistons 5B and 6D are displaced so as to move away (retreat) from disc rotors 4, 4. Consequently, the brake pads 6C are separated away from the disc rotors 4, 4, and the vehicle returns to a non-braking state.

When the operator of the vehicle turns the parking brake switch 23 to the braking side (application side), electric power is supplied from the parking brake control device 24 to the electric motors 7A of the right and left rear wheel-side disc brakes 6, to thereby rotationally drive the electric motors 7A. In the rear wheel-side disc brakes 6, the rotative motion of the electric motors 7A is converted into linear motion by the rotation-linear motion conversion mechanisms 8, and the pistons 6D are propelled by the rotation-linear motion members 8A. The disc rotors 4 are then pressed by the brake pads 6C. At this moment, the rotation-linear motion conversion mechanisms 8 (linear motion members 8A2) are maintained in the braking state, for example, by a frictional force (maintaining force) created by screw engagement. The rear wheel-side disc brakes 6 are thus actuated (applied) as a parking brake. In other words, after the power supply to the electric motors 7A is stopped, the pistons 6D are still maintained at braking positions by the rotation-linear motion conversion mechanisms 8.

When the operator turns the parking brake switch 23 to a braking cancellation side (release side), the electric power is supplied from the parking brake control device 24 to the electric motors 7A in such a manner that the motors are rotated in an opposite direction. Due to this power supply, the electric motors 7A are rotated in an opposite direction to during the actuation (application) of the parking brake. The maintenance of the braking force by the rotation-linear motion conversion mechanisms 8 is discontinued, which allows the pistons 6D to be displaced in a direction away from the disc rotors 4. The actuation of the rear wheel-side disc brakes 6 as a parking brake is cancelled (released).

The following description explains, with reference to FIG. 4, control processing that is carried out in the arithmetic circuit 25 of the parking brake control device 24 (that is, control processing of abnormality determination during release). The control processing illustrated in FIG. 4 is repeatedly carried out in predetermined control cycles (for example, 10 milliseconds), for example, during energization of the parking brake control device 24.

The control processing illustrated in FIG. 4 starts in response to activation of the parking brake control device 24 as an ECU. The parking brake control device 24 is activated, for example, when the door beside the driving seat (door opened) or when the ignition is turned on (accessory ON). The parking brake control device 24 determines at S1 whether release is being actuated. For example, S1 determines whether the electric motors 7A are being driven in the releasing direction. If the result of determination at S1 is “NO,” that is, if it is determined that release is not being actuated, the routine proceeds to S2. At S2, an idling abnormality determination result (diagnosis result) is cleared. After the idling abnormality determination result is cleared at S2, the routine returns. In other words, the routine goes back to the start through the return step and repeats the processing at S1 and subsequent steps.

If the result of determination at S1 is “YES,” that is, if it is determined that release is being actuated, the routine proceeds to S3. S3 determines whether the release that is currently actuated is release at the time of starting the vehicle. In other words, S3 determines whether the vehicle starting condition is satisfied. More specifically, S3 determines whether the operator intends to start the vehicle on the basis of a signal of the accelerator, the clutch or the shift position and then determines whether the currently-actuated release is intended to release the parking brake. For example, at S3, it is possible to determine whether the release is the vehicle start release on the basis of whether the accelerator position exceeds the value that enables the vehicle to start. Instead of depending on the accelerator position, whether the release is the vehicle start release may be determined, for example, depending on whether the throttle position exceeds the value that enables the vehicle to start, whether the engine torque command value exceeds the value that enables the vehicle to start, whether the fuel injection amount exceeds the value that enables the vehicle to start, whether the shift position is turned to the position corresponding to the start of the vehicle (for example, drive position, first gear) and/or whether the digital camera installed in the vehicle informs that a traffic light ahead of the vehicle is switched to “go” (green light).

If the result of determination at S3 is “YES,” that is, if it is determined that the currently-actuated release is the vehicle start release, the routine proceeds to S4. If the result of determination at S3 is “NO,” that is, if it is determined that the currently-actuated release is not the vehicle start release, the routine proceeds to S7. S4 determines whether the idling abnormality diagnosis is not yet confirmed. More specifically, S4 determines during the currently-actuated release whether it is confirmed by the idling abnormality diagnosis in S5 to S10 mentioned later whether an idling abnormality occurs. If the result of determination at S4 is “YES,” that is, if it is determined that the idling abnormality is not yet confirmed, the routine proceeds to S5. If the result of determination at S4 is “NO,” that is, if it is determined that the occurrence of the idling abnormality is confirmed, the routine returns.

S5 determines whether the vehicle starts within a predetermined period of time (for example, within a few seconds or a few tens of seconds) after the release begins. In other words, S5 determines whether the vehicle starts when the predetermined period of time elapses after the release begins. Whether the vehicle is allowed to start can be determined on the basis of the wheel speed of the wheels to which the electric parking brakes are provided, the vehicle speed, estimated torque, the engine speed, and estimated speed obtained by the environment visual recognition device such as a digital camera. S5 thus detects the vehicle's initial motion as the vehicle's running state.

The vehicle's initial motion, that is, whether the vehicle starts moving can be determined from a change in acceleration (longitudinal acceleration) detected by the acceleration sensor, acceleration obtained by differentiating speed, the vehicle speed and/or the wheel speed. For example, if the wheel speed is used, the determination can be made on the basis of whether wheel speed equivalent to one rotation of the wheels (which makes the vehicle move 1 meter) within a predetermined period of time (rotary pulse) is detected. The predetermined period of time and a threshold value of the speed for making the determination as to whether the vehicle starts are previously obtained, for example, by calculation, an experiment, simulation or the like so as to become values (judgment values, threshold values) that enable an accurate determination as to whether the vehicle cannot start due to an abnormality (idling abnormality) in the electric mechanism. The obtained values are stored in the memory 26 of the parking brake control device 24.

If the result of determination at S5 is “YES,” that is, if S5 determines that the vehicle starts within the predetermined period of time, it is determined that the idling abnormality generated during release does not occur. In such a case, the routine proceeds to S6 and confirms that the result of the release idling abnormality diagnosis is “normal.” The routine then returns. If the result of determination at S5 is “NO,” that is, it is determined that the vehicle does not start within the predetermined period of time, there is a possibility that an abnormality occurs. The routine therefore proceeds to S7.

In order to determine whether there is an abnormality on the basis of the motor current value, S7 determines whether the current value immediately after the release is smaller than a predetermined current threshold value. More specifically, S7 determines whether the motor current value becomes equal to or larger than the predetermined current threshold value or smaller than the predetermined current threshold value, for example, on the basis of load for displacing the linear motion member 8A2 of the rotation-linear motion conversion mechanism 8 from the applied state to the release side immediately after the release. The predetermined current threshold value is previously obtained, for example, by calculation, an experiment, simulation or the like so as to become a threshold that enables an accurate determination as to whether the abnormality (idling abnormality) occurs in the electric mechanism from the current value obtained immediately after the release. The predetermined current threshold value is then stored in the memory 26 of the parking brake control device 24.

If the result of determination at S7 is “NO,” that is, if it is determined that the current value immediately after the release is not smaller than the predetermined current threshold value, or to put it differently, that the current value immediately after the release is equal to or larger than the predetermined current threshold value, the routine proceeds to S6. In such a case, it can be determined that an idling abnormality generated during the release does not occur. The routine therefore proceeds to S6 and returns. If the result of determination at S7 is “YES,” that is, it is determined that the current value immediately after the release is smaller than the predetermined current threshold value, the routine proceeds to S8. When this happens, it is highly likely that the abnormality during the release occurs. In order to confirm that the abnormality is the idling abnormality generated during the release, the electric motors 7A are driven in the applying direction at S8. In other words, the electric mechanism is actuated in the applying direction. The subsequent step S9 determines whether thrust is generated within a predetermined period of time. The determination of thrust generation can be made, for example, by whether the motor current value becomes larger than a no-load current value by an amount equal to or larger than a predetermined value. The predetermined period of time and the predetermined value are previously obtained, for example, by calculation, an experiment, simulation or the like so as to become values (judgment values, threshold values) that enable an accurate determination that thrust is generated, or that an idling abnormality does not occur. The obtained values are stored in the memory 26 of the parking brake control device 24.

If the result of determination at S9 is “YES,” that is, if it is determined that thrust is generated within the predetermined period of time, the routine proceeds to S12. In such a case, it can be determined that the idling abnormality generated during the release does not occur. At S12, therefore, the electric motors 7A are driven in the releasing direction (the electric mechanism is actuated in the releasing direction). The routine then proceeds to S6. If the result of determination at S9 is “NO,” that is, it is determined that thrust is not generated within the predetermined period of time, the routine proceeds to S10. In such a case, it can be determined that the idling abnormality generated during the release occurs. S10 therefore confirms that the result of the release idling abnormality diagnosis is “abnormal.” The subsequent step S11 performs a fail action, and the routine returns. The fail action informs of an idling abnormality by blinking the parking brake working light, tuning on the warning light, indicating the occurrence of the idling abnormality in the monitor of the car navigation system or the meter monitor and/or generating warning sounds. At the same time, the fact that the idling abnormality occurs is stored in the memory 26 of the parking brake control device 24.

According to the embodiment, as discussed above, the parking brake control device 24 does not proceed to processing at S8 illustrated in FIG. 4 when determining that an idling abnormality does not occur in the electric mechanism from the vehicle's running state (namely, the processing at S5 in FIG. 4). It is then not necessary to drive the electric motors 7A in the applying direction to determine whether there is an idling abnormality in the electric mechanism. In other words, if it is determined by the processing at S5 in FIG. 4 that the idling abnormality does not occur in the electric mechanism from the vehicle's running state after the electric motors 7A are driven in the releasing direction (when the predetermined period of time elapses after the electric motors 7A are driven), there is no necessity for driving the electric motors 7A in the applying direction in order to determine whether there is an idling abnormality. This represses the impartation of the braking force that the operator does not intend to apply when starting the vehicle or in another situation and therefore prevents or reduces an uncomfortable feeling given to the operator.

According to the embodiment, after the vehicle starting condition is satisfied by the processing at S3 in FIG. 4, and the electric motors 7A are driven in the releasing direction, if it is determined from the vehicle's running state by the processing at S5 in FIG. 4 that the idling abnormality does not occur in the electric mechanism, the routine does not proceed to the processing at S8 in FIG. 4. This eliminates the necessity for driving the electric motors 7A in the applying direction in order to determine whether there is an idling abnormality. In this aspect, too, it is possible to repress the impartation of the braking force that the operator does not intend to apply when starting the vehicle and therefore prevent or reduce an uncomfortable feeling given to the operator. In such a case, since the routine proceeds to the processing at S5 in FIG. 4 after it is determined by the processing at S3 in FIG. 4 that the vehicle starting condition is satisfied, a predetermined period of time used for the processing at S5 can be shortened. In other words, it is already determined by the processing at S3 in FIG. 4 that the operator has the intention to start the vehicle, which reduces the predetermined period of time for determining whether the vehicle starts within the predetermined period of time in the processing at S5 in FIG. 4.

According to the embodiment, if it is determined by the processing at S5 (and S7) in FIG. 4 that the electric mechanism has an abnormality, the electric motors 7A are driven in the applying direction (direction of maintaining the braking state) by the processing at S8 in FIG. 4. In such a case, in other words, if it is determined from the vehicle's running state that the electric mechanism has an abnormality, it is possible to determine whether there is an abnormality in the electric mechanism also by driving the electric motors 7A in the applying direction as well as by checking the vehicle's running state by the processing at S5 in FIG. 4. This enables a highly accurate determination as to whether the abnormality occurs in the electric mechanism.

According to the embodiment, whether the vehicle starting condition is satisfied is determined by the processing at S3 in FIG. 4 on the basis of a change in at least one of the accelerator position, the throttle position, the engine torque command value, the fuel injection amount, the shift position, the parking brake switch information, and the traffic light information. It is therefore possible to determine with high accuracy whether the vehicle starting condition is satisfied (whether the operator has the intention to start the vehicle).

According to the embodiment, it is determined whether there is an abnormality (idling abnormality) in the electric mechanism by the processing at S5 in FIG. 4. At S5 in FIG. 4, when the vehicle's initial motion is detected as the running state, it is determined that the electric mechanism is normal. This way, it can be determined with high accuracy that the electric mechanism is normal. If the abnormality (idling abnormality) does not occur in the electric mechanism, the vehicle's initial motion is detected by deactivating the parking brake. This makes it possible to determine that the electric mechanism is normal.

According to the embodiment, the vehicle's initial motion is determined (detected) on the basis of a change in at least one of the acceleration, the vehicle speed, and the wheel speed. When a change in at least one of the acceleration, the vehicle speed, and the wheel speed is within a predetermined range, it is determined that there is an abnormality in the electric mechanism. More specifically, when the abnormality (idling abnormality) occurs in the electric mechanism, the parking brake is not released. This discourages a smooth initial motion of the vehicle (for example, keeps the vehicle stopped), and a change in at least one of the acceleration, the vehicle speed, and the wheel speed is within the predetermined range. This makes it possible to determine that there is an abnormality in the electric mechanism.

The embodiment has been discussed, taking as an example a case in which, if the result of determination at S1 in FIG. 4 is “YES,” that is, if it is determined that release is being actuated, whether the vehicle starting condition is satisfied is determined by the processing at the subsequent S3 in FIG. 4. The embodiment, however, does not necessarily have to be thus configured. The routine may omit the processing at S3 in FIG. 4 and proceed to S4 in FIG. 5 when it is determined at S1 in FIG. 5 that release is being actuated (the result of determination is “YES”), for example, as in a modification example illustrated in FIG. 5. As illustrated in FIG. 5, regardless of whether the vehicle starting condition is satisfied, the parking brake control device 24 may determine whether there is an abnormality in the electric mechanism from the vehicle's running state by the processing at S5 after driving the electric motors 7A in the releasing direction (when the predetermined period of time elapses after the electric motors 7A are driven).

Such a modification example illustrated in FIG. 5 corresponds to an embodiment that is carried out in a case where it is not possible to determine whether the release is actuated in response to a command to actuate the vehicle start release or by the operation of the parking brake switch. For example, when software of the electric parking brake is incorporated into a microcomputer (ECU, ESC control device 17) mounted on an antiskid brake system or in another like situation, it might be impossible to discriminate the vehicle start release from the release by switch operation. The modification example illustrated in FIG. 5 makes it possible to make an abnormality determination at the time of release.

The “predetermined period of time” under S5 of FIG. 5 may be set, for example, a few seconds or a few hours. In other words, the “predetermined period of time” under S5 of FIG. 5 (and FIG. 4 mentioned above) and the “threshold value of the speed for making the determination as to whether the vehicle starts” are previously obtained, for example, by calculation, an experiment, simulation or the like so as to become values (judgment values, threshold values) that enable an accurate determination as to whether the vehicle cannot start due to an abnormality (idling abnormality) of the electric mechanism. The obtained values are stored in the memory 26 of the parking brake control device 24. The “predetermined period of time” here is preferably, for example, as short as possible without causing an erroneous detection.

The embodiment has been discussed, taking as an example a case in which the rear wheel-side disc brakes 6 are the hydraulic disc brakes with the electric parking brake function, and the front wheel-side disc brakes 5 are the hydraulic disc brakes without an electric parking brake function. Instead of the aforementioned configuration, the invention may be so configured, for example, that the rear wheel-side disc brakes 6 are hydraulic disc brakes without the electric parking brake function, and the front wheel-side disc brakes 5 are hydraulic disc brakes with the electric parking brake function. The invention may also be so configured that both the front wheel-side disc brakes 5 and the rear wheel-side disc brakes 6 are hydraulic disc brakes with the electric parking brake function. In other words, the brakes of at least either one of the pairs of right and left wheels of the vehicle may comprise electric parking brakes.

The embodiment has been discussed, taking the hydraulic disc brakes 6 with the electric parking brakes as an example of the brake mechanisms. The brake mechanisms do not necessarily have to be disc brake mechanisms but instead may be drum brake mechanisms. It is also possible to employ electric parking brakes in various configurations including a drum-in-disc brake that is a disc brake provided with a drum-type electric parking brake, a parking brake that is maintained by pulling a cable using an electric motor, and the like.

The electric brake device and the electric brake control device according to the embodiment discussed above may be configured, for example, in the following modes.

An electric brake device according to a first mode comprises an electric mechanism configured to convert a rotative force of an electrical motor into thrust by using a speed reducer and a rotation-linear motion conversion mechanism and press a braking member against a braked member by propelling a piston to maintain a braking state of a vehicle; and a control device configured to obtain a running state of the vehicle and control the driving of the electrical motor. The control device drives the electrical motor to discontinue the maintenance of the braking state and then determines from the running state of the vehicle whether there is an abnormality in the electric mechanism.

According to the first mode, when it is determined from the vehicle's running state that an abnormality (idling abnormality, for example) does not occur in the electric mechanism, it becomes unnecessary to drive the electrical motor to maintain the braking state in order to determine whether there is an abnormality. In other words, if it is determined from the vehicle's running state that the abnormality does not occur in the electric mechanism after the electrical motor is driven to discontinue the maintenance of the braking state, it becomes unnecessary to drive the electrical motor to maintain the braking state in order to determine whether there is the abnormality. It is therefore possible to repress the impartation of the braking force that the operator does not intend to apply when starting the vehicle or in another like situation and prevent or reduce an uncomfortable feeling given to the operator.

In a second mode according to the first mode, the control device determines from the vehicle's running state whether there is an abnormality in the electric mechanism after a condition for starting the vehicle is satisfied, and the electrical motor is driven to discontinue the maintenance of the braking state.

According to the second mode, when it is determined from the vehicle's running state that an abnormality (idling abnormality, for example) does not occur in the electric mechanism after the vehicle starting condition is satisfied, and the electrical motor is driven to discontinue the maintenance of the braking state, it becomes unnecessary to drive the electrical motor to maintain the braking state in order to determine whether there is an abnormality. It is therefore possible to repress the impartation of the braking force that the operator does not intend to apply when starting the vehicle and prevent or reduce an uncomfortable feeling given to the operator.

In a third mode according to the first mode, the control device drives the electrical motor in a direction of maintaining the braking state when it is determined that the electric mechanism has an abnormality. According to the third mode, it is determined from the vehicle's running state that the electric mechanism has an abnormality (idling abnormality, for example). In such a case, in other words, if it is determined from the vehicle's running state that the electric mechanism has an abnormality, it is possible to determine whether there is an abnormality in the electric mechanism also by driving the electrical motor in the direction of maintaining the braking state. This enables a highly accurate determination as to whether the abnormality occurs in the electric mechanism.

In a fourth mode according to the second mode, the vehicle starting condition is to detect a change in at least one of an accelerator position, a throttle position, an engine torque command value, fuel injection amount, a shift position, parking brake switch information, and traffic light information. According to the fourth mode, whether the vehicle starting condition is satisfied can be determined with high accuracy.

In a fifth mode according to the first mode, the control device determines that the electric mechanism is normal when detecting initial motion of the vehicle as the running state. According to the fifth mode, it is possible to determine with high accuracy that the electric mechanism is normal. In other words, if the abnormality (idling abnormality, for example) does not occur in the electric mechanism, the vehicle's initial motion is detected by cancelling the braking. It is then determined that the electric mechanism is normal.

In a sixth mode according to the fifth mode, the vehicle's initial motion is detected on the basis of a change in at least one of acceleration, vehicle speed, and wheel speed. When the change in at least one of them is within a predetermined range, the control device determines that there is an abnormality in the electric mechanism. According to the sixth mode, it is possible to determine with high accuracy that there is the abnormality in the electric mechanism. In other words, if the abnormality (idling abnormality, for example) occurs in the electric mechanism, the braking is not cancelled. This discourages a smooth initial motion of the vehicle, and a change in at least one of acceleration, vehicle speed, and wheel speed falls within the predetermined range. This makes it possible to determine that there is an abnormality in the electric mechanism.

In a seventh mode, an electric brake control device controls an electrical motor of an electric mechanism that presses a braking member against a braked member of a vehicle to maintain a braking state. The electric brake control device determines whether there is an abnormality in the electric mechanism from a running state of the vehicle which is obtained when a predetermined period of time elapses after the electrical motor is driven to discontinue maintenance of the braking state.

According to the seventh mode, when it is determined from the vehicle's running state that the abnormality (idling abnormality, for example) does not occur in the electric mechanism, it becomes unnecessary to drive the electrical motor to maintain the braking state in order to determine whether there is an abnormality. In other words, when it is determined that the abnormality does not occur in the electric mechanism from the vehicle's running state which is obtained when a predetermined period of time elapse after the electrical motor is driven to discontinue the maintenance of the braking state, it becomes unnecessary to drive the electrical motor to maintain the braking state in order to determine whether there is an abnormality. This represses the impartation of the braking force that the operator does not intend to apply when starting the vehicle or in another situation and therefore prevents or reduces an uncomfortable feeling given to the operator.

In an eighth mode according to the seventh mode, when it is determined that the electric mechanism has an abnormality, the electrical motor is driven in a direction of maintaining the braking state. According to the eighth mode, it is determined from the vehicle's running state that the electric mechanism has an abnormality (idling abnormality, for example). In such a case, in other words, if it is determined from the vehicle's running state that the electric mechanism has an abnormality, it is possible to determine whether there is an abnormality in the electric mechanism also by driving the electrical motor in the direction of maintaining the braking state. This enables a highly accurate determination as to whether the abnormality occurs in the electric mechanism.

In a ninth mode according to the seventh mode, it is determined that the electric mechanism is normal when initial motion of the vehicle is detected as the running state. According to the ninth mode, it can be determined with high accuracy that the electric mechanism is normal. In other words, if the abnormality (idling abnormality, for example) does not occur in the electric mechanism, the vehicle's initial motion is detected by cancelling the braking. This makes it possible to determine that the electric mechanism is normal.

In a tenth mode according to the ninth mode, the vehicle's initial motion is detected on the basis of a change in at least one of acceleration, vehicle speed, and wheel speed. When the change in at least one of them is within a predetermined range, it is determined that there is the abnormality in the electric mechanism. According to the tenth mode, it can be determined with high accuracy that there is the abnormality in the electric mechanism. In other words, when the abnormality (idling abnormality, for example) occurs in the electric mechanism, the braking is not cancelled. This discourages a smooth initial motion of the vehicle, and a change in at least one of the acceleration, the vehicle speed, and the wheel speed falls within the predetermined range. This makes it possible to determine that there is an abnormality in the electric mechanism.

The invention is not limited to the above-discussed embodiments and may be modified in various ways. For example, the embodiments are intended to describe the invention in detail for easy understanding and do not necessarily have to include all the configurations mentioned above. The configuration of each embodiment may be partially replaced with another configuration or incorporated with another configuration. It is also possible to incorporate, omit or replace a part of the configuration of one of the embodiments into, from or with the configuration of another one of the embodiments.

The present application claims priority under Japanese Patent Application No. 2018-028762 filed on Feb. 21, 2018. The entire disclosure of Japanese Patent Application No. 2018-028762 filed on Feb. 21, 2018 including the description, claims, drawings and abstract, is incorporated herein by reference in its entirety.

### REFERENCE SIGN LIST

4: disc rotor (braked member)
6: rear wheel-side disc brake
6C: brake pad (braking member)
6D: piston
7A: electric motor (electrical motor, electric mechanism)
8: rotation-linear motion conversion mechanism (electric mechanism)
24: parking brake control device (control device, electric brake control device)

1. An electric brake device comprising:
an electric mechanism configured to convert a rotative force of an electrical motor into thrust by using a speed reducer and a rotation-linear motion conversion mechanism and press a braking member against a braked member by propelling a piston to maintain a braking state of a vehicle; and
a control device configured to obtain a running state of the vehicle and control driving of the electrical motor,
the control device being configured to drive the electrical motor to discontinue the maintenance of the braking state and then determine from the running state of the vehicle whether there is an abnormality in the electric mechanism.

2. The electric brake device according to claim 1,
wherein the control device determines whether there is an abnormality in the electric mechanism from the running state of the vehicle after a condition for starting the vehicle is satisfied, and the electrical motor is driven to discontinue the maintenance of the braking state.

3. The electric brake device according to claim 1,
wherein the control device drives the electrical motor in a direction of maintaining the braking state when it is determined that the electrical motor has an abnormality.

4. The electric brake device according to claim 2,
wherein the control device detects the vehicle starting condition from a change in at least one of an accelerator position, a throttle position, an engine torque command value, fuel injection amount, a shift position, parking brake switch information, and traffic light information.

5. The electric brake device according to claim 1,
wherein the control device determines that the electric mechanism is normal when detecting initial motion of the vehicle as the running state.

6. The electric brake device according to claim 5,
wherein the control device detects the initial motion of the vehicle on the basis of a change in at least one of acceleration, vehicle speed, and wheel speed; and
wherein when the change in at least one of them is within a predetermined range, the control device determines that there is an abnormality in the electric mechanism.

7. An electric brake control device that controls an electrical motor of an electric mechanism that presses a braking member against a braked member of a vehicle to maintain a braking state,
the electric brake control device being configured to determine whether there is an abnormality in the electric mechanism from a running state of the vehicle which is obtained when a predetermined period of time elapses after the electrical motor is driven to discontinue maintenance of the braking state.

8. The electric brake control device according to claim 7,
wherein when it is determined that the electric mechanism has an abnormality, the electric brake control device drives the electrical motor in a direction of maintaining the braking state.

9. The electric brake control device according to claim 7,
wherein the electric brake control device determines that the electric mechanism is normal when initial motion of the vehicle is detected as the running state.

10. The electric brake control device according to claim 9,
wherein the electric brake control device detects the initial motion of the vehicle on the basis of a change in at least one of acceleration, vehicle speed, and wheel speed, and
wherein the electric brake control device determines that there is the abnormality in the electric mechanism when the change in at least one of them is within a predetermined range.
